(19) United States
(12) Patent Application Publication
(10) Pub. No.: US 2008/0057258 A1
(43) Pub. Date: Mar. 6, 2008

(54) MOLD BODY AND METHOD OF MANUFACTURING THE SAME

(75) Inventors: Masayoshi Kanno, Kanagawa (JP); Yuya Aoki, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/831,617

(22) Filed: Jul. 31, 2007

(30) Foreign Application Priority Data
Aug. 4, 2006 (JP) P2006-212976

(51) Int. Cl. B32B 3/02; B29C 45/00

(52) U.S. Cl. 428/64.4; 264/241

(57) ABSTRACT

A mold body and method of manufacturing the mold body is provided. The mold body includes a resin-molded IC tag module with an integrated antenna and a molding material sealing the IC tag module. The molding material is any one simple thermoplastic resin selected from the consisting of aliphatic polyester, polystyrene, methyl polymethacrylate, polyacetal, polyethylene, polypropylene, polyamide 11 and polyamide 12, or a material containing any one or more of the thermoplastic resins. The method of manufacturing a mold body includes providing a resin-molded IC tag module with an integrated antenna; and sealing at the same time with injection molding the resin-molded IC tag module by using the thermoplastic resin or the thermoplastic material.

### CROSS REFERENCES TO RELATED APPLICATIONS

The present application claims priority to Japanese Patent Application No. 2006-212976 filed on Aug. 4, 2006, the entire content of which being incorporated herein by reference.

### BACKGROUND

The present disclosure relates to a mold body configured as sealing a resin-molded IC tag module with an integrated antenna, and in particular to an enclosure of an electronic device or optical disc mold body having an IC tag module incorporated therein.

There has been known an inexpensive bar code label, as a power-source-less, non-contact ID, for more efficient distribution and management, and traceability of products. However, the bar code label, less durable against scratching and fouling, and often placed on packaging materials, rather than on products to be packaged therein was not practical when considered on the basis of life cycle spanning from manufacture to disposal of the products. Even protection of the label with a resin film or the like does not give a fundamental solution against scratching and fouling, whereas the need of adhesion of the label onto products raises another problem of adhesion failure or separation, or need of space for adhesion.

In such situation, there is an increasing trend of using IC tags in a form of IC. This is advantageous in terms of allowing non-contact reading, or read/write operation, and having an information capacity larger than that of the conventional bar code. Such IC tags, clearly, discriminated from conventional means for identification, is therefore expected for rapid expansion of its quantity and range of use.

Besides efforts of lowering price of the IC tags per se through mass production, there has also been developed an IC tag module technique, such as integrating a communication antenna into an IC as described in Japanese Unexamined Patent Application Publication No. 08-276458 or Japanese Unexamined Patent Application Publication No. 2002-163627. As the Unit price of the IC tag is to drop, there is a great prospect of mounting electronic tags onto a wide range of commodities.

However, the main stream of way of mounting the IC tag onto commodities at present is generally such as bonding and placing it after being processed in a form of an IC tag sheet (a sheet referred to as “inlet”, processed in a form of a film), needing a considerable number of process steps and costs. It has also many issues in durability and security, with fear of raising failures ascribable to breakage and deterioration so that it is considered as inappropriate as a means for mounting onto electronic device as durable consumer goods. Moreover, countermeasures for illegal actions such as misappropriating the IC tag, will be beneficial in the future.

Another issue of the IC tag, resides in its high cost for mounting through adhesion or bonding, and poor durability. For an exemplary case where one wishes to impart an ID to durable consumer goods such as home electric appliances, it is necessary for the ID tag to ensure function of product identification, even after its initial use. Since the average service life of a TV is considered to be around 10 years, and even longer than 20 years for the case of prolonged use, a required service life of ID will supposedly be at least 20 years, and practically 30 years or longer. As for application in the field of security, such as protection of copyright, additional requirement will arise in resistivity against illegal actions.

### SUMMARY

The present application addresses the above-identified issues associated with the developing technologies. One effect of the present embodiments is to provide a mold body having, incorporated therein, an IC tag obtainable at low cost, less causative of quality degradation induced by impact and changes in temperature and humidity, less susceptible to illegal actions, and capable of preventing the reliability -from degrading over a long period, and a method of manufacturing the same.

According to an illustrative embodiments there is provided a mold body including a resin-molded IC tag module with an integrated antenna and a molding material sealing the IC tag module. The molding material is one simple thermoplastic resin selected from the group consisting of aliphatic polyester, polystyrene, methyl polymethacrylate, polyacetal, polyethylene, polypropylene, polyamide 11 and polyamide 12, or a material containing one or more thermoplastic resins selected from the group consisting of aliphatic polyester, polystyrene, methyl polymethacrylate, polyacetal, polyethylene, polypropylene, polyamide 11 and polyamide 12.

The molding material herein is preferably such as being obtained by injection molding at a molding temperature of 230° C. or below.

The mold body is preferably formed to a shape of optical disc, and the IC tag module is preferably disposed in a disc clamp area.

According to another illustrative embodiments, there is provided a method of manufacturing a mold body which includes providing a resin-molded IC tag module with an integrated antenna, and sealing, at the same time with injection molding the resin-molded IC tag module, by using a molding material. The molding material is any one simple thermoplastic resin selected from the group consisting of aliphatic polyester, polystyrene, methyl polymethacrylate, polyacetal, polyethylene, polypropylene, polyamide 11 and polyamide 12, or a material containing one or more thermoplastic materials selected from the group consisting of aliphatic polyester, polystyrene, methyl polymethacrylate, polyacetal, polyethylene, polypropylene, polyamide 11 and polyamide 12.

The molding material herein is preferably injected for molding at a molding temperature of 230° C. or below.

The mold body of the illustrative embodiment shows an excellent long-term reliability, because a semiconductor device of the IC tag is exposed to only a small damage in the process of molding, and doubly sealed. In addition, restriction on the module is moderated, because soldering failure due to re-melting of solder inside the IC tag module is avoidable, and thereby electronic circuits to be sealed can be bonded by soldering at low costs.

According to another illustrative embodiment, a product-specific ID, applicable to copyright protection and charging, can be attached by integrated molding and sealing, at low costs.

These and other features and aspects are set forth in detail below with reference to the accompanying drawings in the following detailed description of the embodiments.

Additional features and advantages are described herein and will be apparent from, the following Detailed Description and the figures.

### BRIEF DESCRIPTION OF THE FIGURES

FIGS. 1A to 1C are schematic drawings showing a configuration of an optical disc mold body as an example of the mold body according, to an embodiment;

FIG. 2 is a schematic drawing showing a configuration of an injection molding machine used for manufacturing of the mold body of an embodiment; and

FIG. 3 is a drawing showing a management profile of solder reflow temperature.

### DETAILED DESCRIPTION

Paragraphs below will explain the mold body according to an embodiment.

The mold body, of an illustrative embodiment is a mold body having a resin-molded IC tag module with an integrated antenna sealed therein by a molding material, where the molding, material contains at least any one thermoplastic resin selected from aliphatic polyester, polystyrene methyl polymethacrylate, polyacetal, polyethylene, polypropylene, polyamide 11 and polyamide 12.

The IC tag module sealed into the mold body is the one integrated with an antenna, referred to as an RFID (radio frequency identification). This is passive-type IC tag covering all functions of IC tag by the chip alone, without need of having any power source and is exemplified by “Tag (ACCUWAVE-IM0505- SLI)” (5.45-mm square, 0.76 mm thick) from Dai Nippon Printing Co., Ltd., “Coil-On-Chip RFID(ME-Y2000)” (2.5-mm square) from Hitachi Maxell, Ltd., and so forth. These IC tag modules are molded by epoxy resin.

Communication distance of the IC tag is generally determined by frequency band to be used, antenna size, reader output power and so forth, mostly fallen in the range from several millimeters to several meters, wherein those with integrated antenna tends to be shortened in the communication distance due to limited size of their antennas. Communication distance of those exemplified herein falls in the range from several millimeters to 30 mm when used in combination with a weak-power-type reader/writer.

The molding material composing the mold body of the illustrative embodiment is made of a simple thermoplastic resin having a melting point or a fusing temperature of 230° C. or below, or a material containing such thermoplastic resin. The thermoplastic resin referred to herein can be exemplified by aliphatic polyester, polystyrene, methyl polymethacrylate, polyacetal (m.p. 180 to 210° C.), polyethylene (m.p. 130 to 135° C.), polypropylene (m.p. 165° C.), polyamide 11 (m.p.183 to 187° C.), and polyamide 12 (m.p. 183 to 187° C.), for example.

The aliphatic polyester is a biodegradable organic polymer compound (biodegradable polymer compound). The biodegradable polymer compound is a compound decomposed, after use, to finally produce water and carbon dioxide in natural environment by contribution of microorganisms (Biodegradable Plastics Society, ISO/TC-207,SC3).

Preferable examples of the aliphatic polyester include polylactates such as poly-L-lactate (PLLA), random copolymer of L-lactic acid and D-lactic acid, or derivatives of these compounds. General polylactate is a highly-biodegradable crystalline polymer having a melting point of 160 to 170° C. or around, and a glass transition point of 58° C. or around. Besides these compounds, also polycaprolactone, poly(hydroxy butyrate), poly(hydroxy valerate), polyethylene succinate, polybutylene succinate, poly(butylene adipate), polymalate, poly(glycolate), polysuccinate ester, polyoxalate, poly(butylene diglycolate), poly(dioxane), microbial synthetic polyester and so forth are applicable, wherein examples of the microbial synthetic polyester include 3-hydroxybutyrate (3HB), 3-hydroxyvalerate (3HV), or copolymers of these compounds.

Molecular weight (number-average molecular weight) of the aliphatic polyester is preferably 30,000 to 200,000 or around. This is because the molecular weight smaller than 30,000 will make strength of the finally-obtained composite composition insufficient, whereas exceeding 200,000 will degrade the moldability and workability.

The molding material may be obtained also by mixing the thermoplastic resin with a resin or a filler having a melting point or a fusing temperature of higher than 230° C., so far as it can be processed by injection molding at a molding temperature of 230° C. or below, as described later. The molding material is fused to attain a viscosity allowing injection molding at 230° C. or below, even if, for example, polylactate is mixed with polycarbonate to an amount of 70% by weight.

The filler is preferably a non-metallic filler not affecting the communication characteristics of the IC tag module, and is exemplified by plant fiber. The plant fiber is preferably mixed with an aliphatic polyester, wherein cotton fiber and paper fiber are preferable, although not specifically limited. The cotton fiber is preferably such as those having an average diameter of 100 μm or smaller. This is because the average diameter exceeding 100 μm may degrade the dispersibility of the filler in the aliphatic polyester, resulting in only insufficient effects of improving rigidity and heat resistance of the finally-targeted compound composition. There is no specific and technical limitation on the lower limit of the average diameter.

The cotton fiber and the paper fiber are preferably used after removing therefrom fatty components by so-called defatting. This is because removal of the fatty components from the cotton fiber makes it ready to uniformly disperse the fiber into the above-described aliphatic polyester, makes it successful to develop effects of improving the rigidity and beat resistance of the finally-targeted composite composition, and can suppress coloration by, the cotton fiber. Defatting is, however, not necessary for the case where the coloration is of no problem in relation to the appearance.

The cotton fiber and paper fiber preferably undergo chemical surface treatment, for the purpose of improving affinity to the above-described aliphatic polyester and dispersibility. Examples of the surface treatment include acylation such as acetylation and benzoylation, and silane coupling treatment.

By this sort of surface treatment, the fiber is improved in the surface adhesiveness with the above-described aliphatic polyester, and is suppressed in degradation of strength due to separation between the resin and the fiber.

Ratio of mixing (weight basis) of the aliphatic polyester and the above-described plant fiber is preferably adjusted to aliphatic polyester/plant fiber=95/5 to 40/60.

A content of plant fiber of less than 5% by weight will fail in obtaining a sufficient level of heat resistance, whereas a content exceeding 60% by weight raises problems disadvantageous to practical material, such as lowering in the strength of the finally obtained composite composition.

Cotton fiber and paper fiber are preferable as the plant fiber, wherein cotton putty is particularly preferable. Cotton putty herein is referred to as fine fiber composed of collected fiber dust produced from weaving process.

The aliphatic polyester is preferably added with a hydrolysis suppressing agent.

The hydrolysis suppressing agent is an additive aimed at suppressing hydrolysis of the aliphatic polyester, exemplified by compounds showing reactivity with active hydrogen in the aliphatic polyester. The agent can reduce the content of active hydrogen in the aliphatic polyester, and thereby the biodegradable polymer chain of the aliphatic polyester can be prevented from being catalytically hydrolyzed by the active

The active hydrogen herein is understood as hydrogen involved in the bond thereof with oxygen nitrogen and so forth (such as N—H bond and O—H bond), wherein such hydrogen have a reactivity later than hydrogen involved in the bond thereof with carbon (C—H bond). More specifically, hydrogens in carboxyl group: —COOH, hydroxyl group: -OH, amino group: —NH₂, or amido bond: —NHCO— and so forth in the biodegradable polymer compound can be exemplified.

Compound showing reactivity with the active hydrogens in the aliphatic polyester can be exemplified by cabodiimide compounds, isocyanate compounds, and oxazoline-base compounds. In particular, the carbodiimide compounds are miscible with the aliphatic polyester under fusion, and only a small amount of addition of which can exhibit an effect of suppressing the hydrolytic tendency.

The carbodiimide compounds refer to compounds having one or more carbodiimide groups in one molecule, and include also polycarbodiimide compounds.

As a method of synthesizing the carbodiimide compounds exemplified is a method of manufacturing based on decarbonation condensation polymerization of various polymer isocyanates at a temperature of approximately 70° C. or above, under solvent-free or in an inactive solvent (for example, hexane, benzene, dioxane, and chloroform), using, as a catalyst, organic phosphorus-containing compound such as dimethyl-(3-methyl-4-nitrophenyl)phosphorothioate, dimethyl-(3)-methyl-4-(methylthio)phenyl)phosphorothioate, and diethyl-2-isopropyl-6-methyl pirimidine-4-yl phosphothioiate, or organo-metallic compounds such as rhodium complex, titanium complex, tungsten complex and palladium complex.

Monocarbodiimide compounds as one category of the carbodiimide compounds can be exemplified by dicyclohexyl carbodiimide, diisopropyl carbodiimide, dimethyl carbodiimide, diisobutyl carbodiimide, dioctyl carbodiimide, diphenyl carbodiimide, naphthyl carbodiimide and so forth, wherein dicyclohexyl carbodiimide and diisopropyl carbodiimide are particularly preferable by virtue of their good industrial availability.

As the isocyanate compounds, typically exemplified are 2,4-tolylene diisocyanate, 2,6-tolylene disocyanate, m-phenylene diisocyanate, p-phenylene diisocyanate, 4,4′-diphenylmethane diisocyanate, 2,4′-diphenylmethane diisocyanate, 2,2′-diphenylmethane diisocyanate, 3,3′-dimethyl-4,4′-biphenylene diisocyanate, 3,3′-dimethoxy-4,4′-biphenylene diisocyanate, 3,3′-dichloro-4,4′-biphenylene diisocyanate, 1,5-naphthalene diisocyanate, 1,5-tetrahydronaphthalene diisocyanate, tetramethylene diisocyanate, 1,6-hexamethylene diisocyanate, dodecamethylene diisocyanate, trimethylhexamethylene diisocyanate, 1,3-cyclohexylene diisocyanate, 1,4-cyclohexylene diisocyanate, xylylene diisocyanate, tetramethylxylylene diisocyanate, hydrogenated xylylene diisocyanate, lysine diisocyanate, isophorone diisocyanate, 4,4′- dicyclohexylmethane diisocyanate and 3,3′-dimethyl-4,4′-(dicyclohexylmethane diisocyanate.

The above-described isocyanate compounds can be synthesized according to any known methods, or may appropriately be available from the commercial products.

As the commercially-available polyisocyanate compounds, aromatic isocyanate adduct such as Colonate (from Nippon Polyurethane Industry Co., Ltd., trade name, hydrogenated diphenylmethane diisocyanate), and Millionate (from Nippon Polyurethane Industry Co., Ltd., trade name) and so forth may be applicable.

In particular, solid is more preferable than liquid, wherein polyisocyanate compounds having, the isocyanate groups blocked with a masking agent (polyvalent aliphatic alcohol, aromatic polyol, and so forth) are preferable.

As the oxazoline-base compounds, exemplified are 2,2′)-o-phenylenebis(2-oxazoline), 2,2′-m-phenylenebis(2-oxazoline), 2,2′-p-phenylenebis(2-oxazoline), 2,2′-p-phenylenebis(4-methyl-2-oxazoline, 2,2′-m-phenylenebis(4,4′-dimethyl-2-oxazoline, 2,2′-ethylenebis(2-oxazoline), 2,2′-tetramethylenebis(2-oxazoline), 2,2′-hexamethylenebis(2-oxazoline), 2,2′-octamethylenebis(2-oxazoline), 2,2′-ethylenebis(4-methyl-2-oxazoline), and 2,2′-diphenylenebis(2-oxazoline).

The finally-obtainable composite composition (those containing the aliphatic polyester, the plant fiber, and the hydrolysis suppressing agent) can be adjustable in terms of the biodegradation speed and mechanical strength, depending on species of the hydrolysis suppressing agent or amount of addition thereof, so that the species and amount of addition are determined, depending on types of the mold body to be manufactured using the composite composition.

More specifically, the amount of addition of the hydrolysis suppressing, agent is preferably set to approximately 7by weight or below.

The hydrolysis suppressing agent may be any of the above-described compounds used alone, or may be any combinations of two or more species of these compounds.

The method of manufacturing the above-described composite composition as the molding material is not specifically limited, allowing adoption of any publicly-known methods. The composition can be manufactured by kneading the aliphatic polyester, the above-described plant fiber and the hydrolysis suppressing agent under fusion. More specifically, in the pre-process of fusing the aliphatic polyester, or in the fusing process, the plant fiber and the hydrolysis suppressing agent are added and mixed.

The plant fiber and the hydrolysis suppressing agent may be added at the same time, or may independently be added. For the case of independent addition, order of addition may be arbitrary

Another possible process is such that the aliphatic polyester is fused, either of the plant fiber or the hydrolysis suppressing agent is added thereto, and the hydrolysis suppressing agent or the plant fiber is added thereto and then mixed

The mold body referred to in the present embodiment means a product molded by injection molding, and is typically stationary AV equipment such as DVD (digital video disc or digital versatile disc) player, CD (compact disc) player, amplifier and so forth; loudspeaker, car-borne AV/IT equipment, PDA such as mobile phone terminal, electronic book and so forth, video recording deck, television set, projector, television receiver, digital video camera, digital still camera printer, radio, radio-cassette tape recorder, stereo system, microphone, headphone, TV, keyboard, portable music equipment such as headphone stereo-audio equipment, personal computer, enclosure of electronic device such as peripheral equipment of personal computer and optical disc mold body.

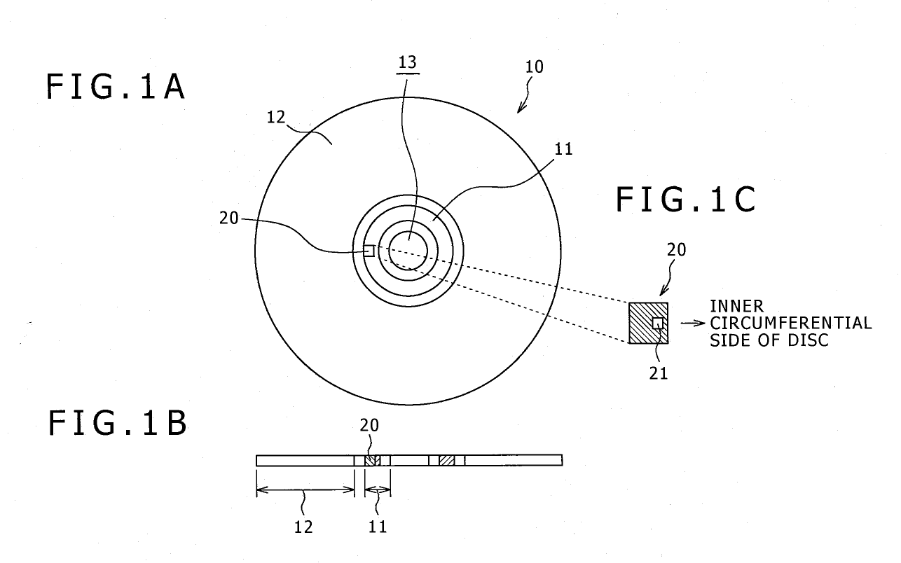

An exemplary configuration of the mold body molded to give a geometry of optical disc will be shown in FIGS. 1A to 1C, FIG. 1A is a front elevation of, an optical disc mold body 10, FIG. 1B is a side elevation thereof, and FIG. 1C is an enlarged view of an IC tag module 20.

The drawings herein show a configuration of an optical disc mold body, destined for DVD or CD, wherein the optical disc mold body 10 is configured as having a disc clamp area 11 and a recording, area 12 molded in an integrated manner, wherein a tag. module 20 is disposed in the disc clamp area 11. The IC tag module 20 herein is preferably disposed so that the center of gravity thereof falls on the inner circumferential side of the optical disc mold body 10. More specifically, the IC tag module 20 is disposed so that an IC chip 21 thereof is positioned on the inner circumferential side of the optical disc mold body 10.

The optical disc incorporated with the tag module will be imbalanced in weight, and will affect a servo system to an unnegligible degree under high-speed rotation. For example, an allowable decentering of gravity is specified for DVD, for the purpose of reducing the load to the servo system for stable reproduction. A smaller value of which means a larger stability under high-speed rotation, wherein the value is specified as 1 g·cm for DVD. Doubled or more high-speed rotation is quite common for optical disc, aimed at raising the bit rate of recording/reproduction, wherein imbalance in weight of the disc is preferably minimized. Because the force of imbalance generated by rotation is proportional to squared angular velocity, so that the allowable decentering of gravity will be given as not larger than ¼ of the reference speed, or not larger than 0.25 g·m, in view of ensuring stable reproduction at a doubled speed.

For this purpose, or example, Japanese Unexamined Patent Application Publication No. 2005-209323, titled “Optical disc with incorporated RFID tag, and system of configuring RFID tag of optical disc”, discloses an effort of reducing the degree of imbalance, by mounting a dummy chip as a balancer.

Rotation-induced force of imbalance can be expressed by the equation below:
(Rotation-induced force of imbalance)=(Imbalance of weight)×(Distance from center)×(Angular velocity)² (1)

In other words, the value can be reduced by a smaller imbalanced weight if compared at the same position under the same speed of rotation, and by positioning the IC tag module more deeply on the inner circumference side of the disc if compared under the same imbalanced weight. However, the center of the disc is a hole not available for mounting, so that the disc has some other area suitable for mounting.

The imbalanced weight can be expressed by the equation (2) below:
(Imbalanced weight)={(IC tag density)−(Resin density)}(IC tag volume) (2)

In order to reduce the imbalanced weight, it is necessary to reduce difference in density between the IC tag, and the resin, or to downsize the IC tag module. For the case where the IC tag module to be used is fixed in type, the value can be reduced by using a resin having a density closer to that of the IC tag module.

The density of the IC tag module is determined by constituents thereof, wherein major constituents include an IC tag chip (silicon) of 2.33 g/cm³, an antenna board (glass-epoxy) of 1.5 to 1.7 g/cm³, and a package mold body (epoxy resin) of 1.8 to 1.9 g/cm³. Because all of these basic constituents are heavier than general plastics used for molding the optical disc, the IC tag module becomes heavier than that of the resin composing the optical disc. For example, density of “M-Tag (ACCUWAVE-IM505-SLI)” (5.45-mm square, 0.76 mm thick) from Dai Nippon Printing Co., Ltd. is 2.0 g/cm³.

Not only mechanical characteristics but also optical characteristics are of great importance for the molding material (resin) used for the optical disc, so that PC (polycarbonate, density=1.2 g/cm³) COP (cycloolefin polymer density=1.01 g/cm³) or the like showing a large transmissivity at shorter wavelengths are used, where additives cannot be used in view of optical characteristics. Even polycarbronate having a large density still differs by 0.8 g/cm³ from the density of the IC tag module. Of the molding material used herein in on embodiment of the present invention, those containing aliphatic polyester have larger density than such material. For example, a thermoplastic resin mainly composed of polyactic acid (H100J from Mitsui (Chemicals Inc.,) has a density of 1.33 g/cm³) raising advantage in reducing the imbalanced weight.

Assuming, that the optical disc mold body shown in FIGS. 1A and 1B as a 12-cm-diameter disc, an inner diameter portion 13 is a center hole of 15 mm, teaching that the area in side a radius of 7.5 mm is not physically available for mounting of the IC tag module. The area outside a diameter of 45 mm (22.5 mm in radius) is provided as a signal recording area 12, and is again not suitable as the mounting area, because this area in ROM disc has a metal reflective film which functions as shortening the communication distance. Taking the manufacturing margin into consideration, an area of 8 to 22 mm in diameter is understood as being appropriate for mounting of the IC tag module. Taking further irregular geometry in the inner circumferential portion into consideration, the flat disc clamp area 11 is understood as being appropriate for disposition of the IC tag module, and the area of 11.0 to 16.5 mm in diameter is understood as being more appropriate.

Another consideration is such that the IC tag module not always has the center of gravity at the geometrical center thereof, because the IC chip (silicon chip) has the largest density. In this case, imbalance of weight can be minimized by disposing the tag so as to make the center of gravity thereof fall on the inner circumferential side of the optical disc, and thereby the optical disc is allowed to rotate in a stable manner (FIG. 1C).

A method of manufacturing the mold body of one embodiment is described below.

The method of manufacturing a mold body of one embodiment is such as sealing, at the same time with injection molding, a resin-molded IC tag module with an integrated antenna, using any one simple thermoplastic resin selected from the group consisting of aliphatic polyester, polystyrene, methyl polymethacrylate, polyacetal, polyethylene, polypropylene, polyamide 11 and polyamide 12, or a material containing any one of more of these thermoplastic resins, wherein the injection molding is preferably carried out at a molding temperature of 230° C. or below.

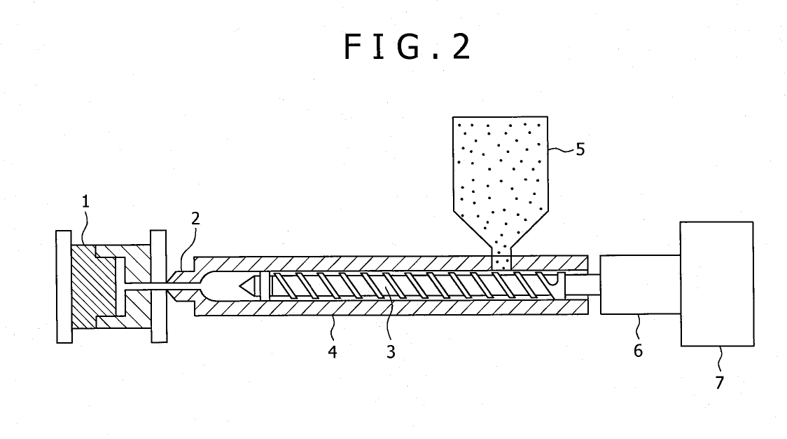

FIG. 2 is shows an exemplary configuration of an injection molding, machine adopted to the method of manufacturing a mold body of an embodiment.

The injection molding machine has a die 1 as a template of the mold body, a nozzle 2 through which a molten molding material is injected into the cavity of the die 1, a screw 3 taking part in plasticizing operations including transfer, compression, kneading fusing, and weighing, a screw cylinder 4 composed as being wrapped on the exterior thereof by a band heater, having the screw 3 incorporated therein allowing therein plasticizing of the molding material, a hopper 5 through which the molding material is fed to the screw , an injection cylinder 6 allowing the screw 3 to advance, and an oil hydraulic motor 7 rotating the screw 3.

The mold body of one embodiment is formed according to the procedures below:

(S11) the resin-molded IC tag module with an integrated antenna is disposed at a predetermined position in the cavity of the die 1;

(S12) the molding material is fed through the hopper 5 to the screw 3, and is transferred with the aid of screw 3 rotated by the oil hydraulic motor 7, while being kept under a molten state under heating, in the screw cylinder 4 towards the nozzle 2; (S13) the screw cylinder 4 is heated at a molding temperature (cylinder temperature) of 230° C. or below, so that the molten molding material stagnated at the nozzle 2 side in the screw cylinder 4 is kept at the molding temperature;

(S14) the stagnated molten molding material is injected into the cavity of the die 1 with the aid of the screw 3 advanced by the injection cylinder 6;

(S15) the molding material is allowed to solidify in the die 1, and is given in a form of mold body corresponded to the geometry of the cavity sealing therein the IC tag module.

Molding time necessary for such injection molding may largely vary depending on the molding material adopted herein, geometry and size of the mold body, and the die being as short as several seconds for molding of optical disc or the like, and as long as several minutes for molding of large-sized or thick components. In the molding process involving injection, pressure keeping, cooling and solidification, the molding material is kept at high temperatures only during, the period up to filling of the resin, so that most processes will come to the end within 1 minute except for the case of molding large components.

The IC tag module is exposed to temperature and pressure through the molten molding material also during the injection molding, so that it is considered as a matter of course that the injection molding at lower temperatures and lower pressures will improve reliability of the IC tag module, and so that it is essential to carry out the molding at lower temperatures and lower pressures in view of minimizing damage to an electronic component in the IC tag module. More specifically, it is necessary to consider thermal influence on the resin mold body of the IC tag module and the internal soldered portion.

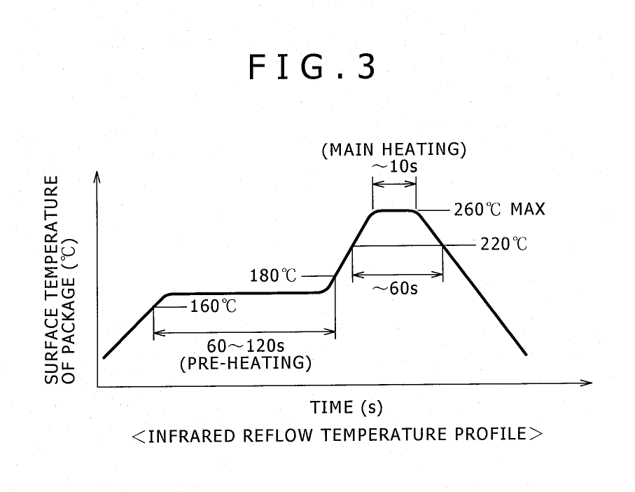

It is generally known that resins used for the IC module degrade by heat. For example, it is known that package crack in the process of solder reflow occurs depending on relations between the moisture absorbed into the package and temperature of the resin composing the resin, and becomes more likely to occur as the moisture content and temperature increase. It is therefore important to suppress the moisture content and temperature of the package to lower levels. Although it is not so often that thermally-induced phenomenon such as blister and crack immediately results in electrical failure, they are known to induce degradation in the moisture resistance. Taking these matters into consideration, the reflow temperature and time are strictly controlled as shown in FIG. 3, wherein in this example, maximum surface temperature of the IC package is kept at 260° C. for 10 seconds, and at 220° C. or above and lower than 260° C. for up to 60 seconds. Because the IC package, in the process of practical mounting on board based on reflow, is also concomitantly exposed to pressure stress due to heat-induced warping of the board, so that the temperature condition other than the peak temperature is supposed to change in a more moderate manner under stress-free conditions.

A general material composing the resin mold body of the IC tag module is a thermosetting resin such as epoxy resin, showing a thermal deformation temperature after being cured of as high as 200° C.; or around. There are some ceramic-sealed IC tag modules durable to higher temperatures, but they cost high and are not general. The thermal deformation temperature referred to as herein means a temperature causative of a predetermined level of deflection under a predetermined load, while giving no information. on fracture of the device, and is considered as one index in the temperature management

In conclusion, temperature to which the package of the IC tag module is exposed is preferably 260° C. or lower and more preferably 230° C. or lower. A temperature of 220° C. is considered as being further preferable, and 200° C. or below is still further preferable. In the process of bonding electronic parts in the module, typically for the case where the antenna and the RFID chip are bonded using a solder, the solder, even being a high melting point type, may be re-melted at 260° C. or above. Also from this point of view, the temperature is preferably controlled to 260° or below.

In order to control the temperature of the molding material in the sealed state (resin temperature (sealing resin temperature) for the case where the molding material is simply composed of a resin only) to 230° C., or below, it is necessary for the molding material to have a melting point or fusing point equivalent to or lower than that temperature. It is well known that difference in temperature between the molding material and the screw cylinder 4 and the nozzle 2 of the injection molding machine varies depending on types of the molding machine, and appropriate infection pressure is susceptible to geometry, of the mold body and gate structure. It is therefore difficult to specify the temperature in the actual state of molding and sealing, but in can generally be stated as follows for small-sized, lightweight products such as package of electronic instruments. That is, temperature of the molding material, fused in the screw cylinder 4 and injected, is affected by shearing heat generation in the process of injection or the like, and lowering in the temperature when brought into contact with the wall of the die 1 set to 100° C. or around or lower, for the convenience of solidification of the molding material. Packages for electronic instruments for example are, however, affected more largely by the wall of the die rather than the shearing heat generation, so that the temperature of the molding material (resin temperature) in the process of molding becomes lower than the temperature set for the screw cylinder.

It is to be noted herein that, in order to ensure fluidity in the die 1, the temperature of the molding material (resin temperature) on the surface of the IC tag module to be sealed is necessarily equivalent to or higher than the melting point of the fusing temperature of the molding material. Temperature of the screw cylinder in the process of molding is therefore assumed as the highest temperature of the molding material in the process of molding and sealing and the melting point or the fusing temperature of the molding material is assumed as the lowest temperature of the molding material in the process of molding and sealing, irrespective of the molding machine and geometry of the mold body.

### EXAMPLES

Paragraphs below describe experiments carried out to examine the present embodiments.

(Experimental Case 1 )

Using actual IC tag modules, damages on the package and surface temperature of the package were experimentally examined. The IC tag module used herein was “M-Tag (ACCUWAVE-IM0505-SLI)” from Dai nippon Printing Co., Ltd. (with an integrated antenna having a communication frequency in 13.56-MHz band, 5.45-mm square, 750 μm thick). The IC tag module alone was heated, and the changes in the state of resin and influences on memory functions were evaluated.

In this experiment, the IC tag module was preheated involving heating at a rate of 2° C./second from normal temperature to 150° C., and keeping of the temperature at 150° C. for 2 minutes, and then substantially heated from 150° C. in four ways as described below. In the heating using halogen lamps in this experiment, holding time in the process of temperature elevation was defined as an inverse of the temperature elevation time.

(Heating Condition 1) heating was effected on a silicon oil bath tip to 230° C., and ended after 2-minute keeping of the temperature at 230° C;

(Heating Condition 2) heating was effected from four directions using halogen lamps at a heating rate of 5° C./second, and ended after a target temperature of 300° C. was reached;

(Heating Condition 3) heating was effected from four directions using halogen lamps at a heating rate of 1° C./second, and ended after a target temperature of 300° C. was reached; and (Heating Condition 4) heating was effected from four directions using halogen lamps up to 330° C., and ended after 5-minute keeping of the temperature.

Evaluation was made by visually observing state of combustion of the resin mold body during heating, whereas color change and deformation of the resin mold body were visually observed and measured after heating when the resin mold body was cooled to normal temperature. The IC tag module after heating was also evaluated whether it can read ID (identification), write (record), and reproduce the written code. The IC tag module was evaluated as “o”, if these operations were successful, and as “x” if these operations resulted into failure. Reading and writing were made through KI-730R from KDR Corporation.

Results of the experiment were shown in Table 1.

The beating and 2-minute keeping of temperature at 230° C. were not causative of color change nor deformation of the package. It is therefore found from the results that temperature of the molding material (sealing resin temperature) in the process of injection molding adjusted to 230° C. or below is effective to suppress thermal damage of the package. The reason why the heating temperature for the case where the heating is effected at a rate of temperature elevation as steep as 5° C. second (held for 0.2 second) under Heating Condition 2, was set to as low as 295° C. is supposedly as a result of influence of local elevation of temperature in the module, rather than achieving therein a uniform temperature distribution. Because this temperature is a starting temperature of combustion, and because the resin per se is imparted with flame resistance, the combustion was not sustained. From these results, a temperature at around 300° C. was causative of irreversible damages on the package. Color change and deformation of the resin mold body were observed as blackening and thickening of the module, respectively, wherein 2% increase in thickness at maximum was observed. The communication performance was confirmed as normal both for ROM and RAM, except for those processed under Heating Condition 4 (heated at 330° C., held for 5 minutes). The damages of the IC tag module observed in this experimental case were supposedly ascribable to degradation in the reliability, which is not causative of electrical failure within a short period, just like the package crack.

TABLE 1

| | | | Result of evaluation | | | | | | |
|---|---|---|---|---|---|---|---|---|---|
| | Highest | | | | | Evaluation of | | | |
| | accesible | | | | | communication | | | |
| | temperature | Holding | Color | | | performance | | | |
| | (° C.) | time | change | Combustion | Deformation | ID | Recording | Reproduction | Remark |
| Process | 230 | 2 minutes | not | not found | not | ◯ | ◯ | ◯ | Silicon oil |
| Condition 1 | | | found | | found | | | | bath |
| Process | 295 | 0.2 | found | found | found | ◯ | ◯ | ◯ | Halogen |
| Condition 2 | | seconds | | | | | | | lamp |
| Process | 302 | 1 | found | found | found | ◯ | ◯ | ◯ | Halogen |
| Condition 3 | | seconds | | | | | | | lamp |
| Process | 330 | 5 minutes | found | found | found | X | X | X | Halogen |
| Condition 4 | | | | | | | | | lamp |

◯: Normal
X: Abnormal

### Example 1

Injection molding was carried out using three types of molding materials, involving a low-melting-point plastic mainly composed of polylactic acid, polystyrene and polycarbonate, while varying the molding temperature. The IC tag module and the molding materials are shown below:
(1) IC tag module: “M-Tag (ACCUWAVE-IM0505-SLI)” from Dai Nippon Printing Co., Ltd. (5.45-mm square, 0.76 mm thick, with an integrated antenna having a communication frequency in 13.56-MHz band);
(2) molding material: selected from three following materials:
   thermoplastic resin mainly composed of polylactic acid (H100J, from Mitsui Chemicals, Inc.);
   thermoplastic resin mainly composed of polystyrene (GPPS HF77, from PS Japan); and
   thermoplastic resin mainly composed of polycarbonate (Panlite L-1225L, from Teijin chemicals, Ltd.).

At the start of the injection molding, the IC tag module was preliminarily placed on the horizontal portion of the die on the movable die. The die was then closed, and injection molding was carried out under the molding conditions shown in Table 2, using an injection molding machine (NEX500, from Nissei Plastic Industrial Co., Ltd.) having a clamping force of 50 tons. The molding temperature herein means set temperature for the cylinder of the injection molding machine. A secondary pressure (sustained pressure) of 30 MPa, an injection time of 15 seconds and a cooling, time of 20 seconds were kept constant irrespective of the molding, temperature.

TABLE 2

| | | Melting point | | | |
|---|---|---|---|---|---|
| | | or fusing | Cylinder | Injection | Die |
| | Major resin | point | temperature | pressure | temperature |
| Molding | Polylactic acid | 164° C. | 175-185° C. | 135 MPa | 30° C. |
| Condition 1 | | | | | |
| Molding | Polystyrene | 180-210° C. | 225-230° C. | 68 MPa | 60° C. |
| Condition 2 | | | | | |
| Molding | Polystyrene | 180-210° C. | 250-260° C. | 53 MPa | 60° C. |
| Condition 3 | | | | | |
| Molding | Poly- | 230-260° C. | 260-270° C. | 160 MPa | 100° C. |
| Condition 4 | carbonate | | | | |
| Molding | Poly- | 230-260° C. | 290-300° C. | 113 MPa | 100° C. |
| Condition 5 | carbonate | | | | |

The IC tag module placed in the die was sealed by injection molding, as being pressed onto the end of the mold body due to flow of the molding material, to thereby give the mold body. Deformation and communication performance of the IC tag module were then evaluated.

For evaluation of deformation of the IC tag module, the IC tag module was taken out from thus-obtained mold body, and the thickness was measured. The thickness was measured using a micrometer. The thickness of the IC tag module before being sealed by the molding material was 750 μm. Communication performance was evaluated similarly to as described in Experimental Case 1.

Results of evaluation were shown in Table 3.

TABLE 3

| | Thickness | | | | |
|---|---|---|---|---|---|
| | of IC tag | | | | |
| | module | Evaluation | Evaluation of | | |
| | after | of | communication performance | | |
| | molding | deformation | ID | Recording | Reproduction |
| Molding | 745 μm | ◯ | ◯ | ◯ | ◯ |
| Condition 1 | | | | | |
| Molding | 749 μm | ◯ | ◯ | ◯ | ◯ |
| Condition 2 | | | | | |
| Molding | 759 μm | X | ◯ | ◯ | ◯ |
| Condition 3 | | | | | |
| Molding | 765 μm | X | ◯ | ◯ | ◯ |
| Condition 4 | | | | | |
| Molding | 756 μm | X | ◯ | ◯ | ◯ |
| Condition 5 | | | | | |

Under Molding Condition 1, the thickness of the IC tag module becomes thinner by 5 μm as compared with the original thickness, because the package is partially collapsed in the thickness-wise direction due to temperature and molding pressure. In contrast, the thickness increases under Molding Conditions 3 to 5 despite pressure is applied. This is apparently a deformation opposite to that caused by heat, wherein increase in the thickness due to warping swelling and so forth on the basis o the result obtained under Molding Condition 1 was specified as the amount of deformation.

Based on consideration that the long-term reliability can be improved by suppressing warping of the IC tag module sealed by the molding material to as small as 1% or below the tag module causing increase in the thickness of 7.5 μm or more was judged as being warped or deformed by heat. The reason why the allowable limit of warping was determined as 1% or below is that a technical report of Hitachi Chemical Co., Ltd., which examines a resin sealing material adapted to lead-free solder reflow process (http://www.hitachi-chem.co.jp/japanease/report/040/40_sou.pdf), specifies a design value of warping of a chip, assumed as a 1.4-mm-thick QFP sealing material as 30 μm as being corresponded to 2% of the thickness of the chip, and the present inventors considered that the 1%limitation, halved from such 2%, would improve the long-term reliability.

Under Molding conditions 1 and 2 adopting low-temperature molding at 230° C. or lower using molding materials having melting points (melting point explained herein includes fusing temperature of resin, because some resins have no melting point ) of 164° C., and 180° C., respectively, the IC tag modules did not cause deformation of 1% or more, and were still operable in communication despite being affected by the injection pressure.

Under Molding Condition 3, injection molding was carried out using the resin same as that used under Molding Condition 2, at a temperature elevated to as high as 260° C., wherein it was supposed that thus-elevated molding temperature consequently elevated the sealing resin temperature, and resulted in deformation. It was therefore found that the molding temperature should not exceed 260° C.

Under Molding Condition 4, injection molding was carried out using a molding material having a melting point of 260° C. at a molding temperature as low as barely allowing the molding to proceed, and under Molding Condition 5, injection molding was carried out using the same molding, material conversely at a molding temperature higher than usual. The Molding Condition 4 is lower in the molding temperature but correspondingly higher in the injection pressure. Deformation was similarly observed under both conditions. Use of the molding material having a melting point of as high as 260° C. was supposed to be inappropriate irrespective of the molding conditions.

All of Molding Conditions 3 to 5 resulted in failure expressed by degradation in long-term reliability without showing short-term electrical failure, implying a high risk of causing failure after delivered into the market, and suggesting difficulty in use of the IC tag module as a built-in type product for which the ID is not readily exchangeable.

As has been described in the above, the mold body of one embodiment, obtained by sealing by molding at low temperatures using a molding material having a low melting point, makes it possible to apply ID, which is robust against illegal actions such as picking out the tag, to commodities, and thereby allows the ID to function in a highly reliable manner over a long period from manufacturing of the commodities to actual use and thereafter.

Isolation from the open air by sealing is known to be preferable in view of ensuring reliability of electronic components such as built-in IC tag module, whereas one embodiment of the present invention, aimed at mounting the IC tag module onto actual commodities while ensuring their reliability, seales the IC tag module into the mold body such as enclosures of the commodities composed of specific molding materials. This configuration not only reduces costs of mounting the IC tag module, but also improves the reliability and security.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1: A mold body comprising:
a resin-molded IC tag module with an integrated antenna; and
a molding material sealing the IC tag module,
wherein the molding material is any one simple thermoplastic rein selected from the group consisting of aliphatic polyester, polystyrene, methyl polymethacrylate, polyacetal, polyethylene, polypropylene polyamide 11 and polyamide 12, or a material containing one or more thermoplastic resins selected from the group consisting of aliphatic polyester polystyrene, methyl polymethacrylate, polyacetal, polyethylene, polypropylene, polyamide 11 and polyamide 12.

2: The mold body as claimed in claim 1, wherein the molding material is obtained by injection molding at a molding temperature of 230° C. or below.

3: The mold body as claimed in claim 1, wherein the mold body is formed to a shape of an optical disc.

4: The mold body as claimed in claim 3, wherein the IC tag module is disposed in a disc clamp area.

5: A method of manufacturing, a mold body comprising:
providing a resin-molded IC tag module with an integrated antenna; and
sealing, at the same time with injection molding, the resin-molded IC tag module by using, a molding material, the molding material being any one simple thermoplastic resin selected from the group consisting of aliphatic polyester, polystyrene, methyl polymethacrylate, polyacetal, polyethylene, polypropylene, polyamide 11 and polyamide 12, or a material containing one or more thermoplastic resins selected from the group consisting of aliphatic polyester, polystyrene, methyl polymethacrylate, polyacetal, polyethylene, polypropylene, polyamide 11 and polyamide 12.

6: The method of manufacturing a mold body as claimed in claim 5, wherein the molding material is injected for molding at a molding temperature of 230° C. or below.
